(19) United States
(12) Patent Application Publication
(10) Pub. No.: US 2024/0142290 A1
(43) Pub. Date: May 2, 2024

(54) METHODS OF LITHIUM LEVEL MEASUREMENT AT ELEVATED TEMPERATURE

(71) Applicant: Applied Materials, Inc., Santa Clara, CA (US)

(72) Inventors: Ajay Balaram MORE, Bangalore (IN); Sambhu KUNDU, Fremont, CA (US); PrasannaKalleshwara Buddappa RAMACHANDRAPPA, Santa Clara, CA (US); Terry BLUCK, Santa Clara, CA (US); Visweswaren SIVARAMAKRISHNAN, Cupertino, CA (US)

(21) Appl. No.: 18/382,314

(22) Filed: Oct. 20, 2023

(30) Foreign Application Priority Data
Oct. 31, 2022 (IN) 202241061826

(51) Int. Cl. G01F 23/24

(52) U.S. Cl. CPC G01F 23/241

(57) ABSTRACT

Methods and systems for the measurement of molten metal and metal alloy levels within a crucible are provided. The system includes a crucible, a probe having an electrode disposed at a lowermost probe position, and a processing system configured to receive a signal from the electrode to evaluate whether the electrode is in contact with the liquid metal. The system can include a plurality of probes, with each probe having an electrode positioned at a different height within the crucible interior. A multi-probe system can inform a system user on molten metal levels at various sectors within the crucible interior.

### CROSS-REFERENCE TO RELATED APPLICATIONS

This application claims the benefit of India Provisional Patent Application No. 202241061826, filed Oct. 31, 2022, which is incorporated by reference herein in its entirety.

### BACKGROUND

### Field

The present disclosure generally relates to methods and systems for measurement of levels of molten metal in crucibles.

### Description of the Related Art

Transistor technology, which began in the 1940s, called for the production of semiconductor materials, such as germanium and silicon, with extremely low impurity concentrations. Since then, innovative melting and purification techniques have continuously advanced.

One area where current technology has not advanced as rapidly is in the determination of metal and alloy levels within sealed crucibles. The production of high purity semiconductor materials often involves on excluding oxygen and other contaminating gases from molten metal processes. The ability to determine the levels of a molten metal within a sealed crucible are often imprecise or unreliable.

Some methods for monitoring the level of molten crucible contents involve using x-ray or gamma radiation. The primary disadvantage of these methods is the difficulty of protecting staff from radiation.

Other methods employ a plurality of thermocouples and measure temperatures at multiple zones within a crucible. The temperatures are indirectly indicative of liquid levels. One disadvantage of these methods is that the crucible interiors are highly temperature-conductive and heat transfer between different zones can lead to inaccurate measurements.

Floats have also been employed, however, mechanical component movement becomes unreliable after the components are submerged in molten metals for long periods of time. Cooling and heating cycles also results in crystallization on metal components, which can hinder movement.

Accordingly, a need remains for methods for accurately determining the levels of liquid metals within a crucible.

### SUMMARY

Implementations described herein generally relate to methods and systems for the determination of molten metal and metal alloy levels in a crucible. The metal can be lithium, silicon, germanium, potassium, calcium, magnesium, aluminum, or any other metal, or combination thereof.

In one implementation, a liquid metal level measurement system is provided. The liquid metal level measurement system includes a crucible that is operable to contain a liquid metal, a probe fixedly coupled to the crucible, and a processing system. The probe comprises an electrode disposed at a lowermost probe position. The processing system is configured to receive a signal from the electrode and evaluate whether the electrode is in contact with the liquid metal.

In another implementation, a multi-probe liquid metal level measurement system is provided. The system includes a crucible that comprises an electrically-conductive material and is operable to contain a liquid metal. The system further includes at least two probes fixedly coupled to the crucible. Each of the at least two probes comprises an electrode at a respective lowermost probe position. The at least two electrodes are disposed within a crucible volume and are electrically-coupled to a multi-loop circuit. The system further includes a processing system that configured to receive a signal from each of the at least two electrodes. The processing system can evaluate whether each of the at least two electrodes is in contact with a liquid metal.

In yet another implementation, a method of measuring a liquid metal level within a crucible is provided. The method includes providing a liquid metal to a crucible that comprises at least one probe fixedly coupled to the crucible. Each of the at least one probe includes an electrode disposed at a lowermost probe position and within a crucible volume. The method further includes receiving a signal from each of the at least one electrode with a processing system that is configured to evaluate whether each of the at least one electrode is in contact with the liquid metal. The method further includes using the processing system to determine a liquid metal level relative to a height of each of the at least one electrode within the crucible.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a schematic view of a single probe liquid metal level measurement system according to one or more implementations of the present disclosure.

FIG. 2 illustrates a schematic view of a circuit of a single probe liquid metal level measurement system according to one or more implementations of the present disclosure.

FIG. 3 illustrates a multi-probe liquid metal level measurement system according to one or more implementations of the present disclosure.

FIG. 4 illustrates a schematic view of a circuit of a dual probe liquid metal level measurement system according to one or more implementations of the present disclosure.

FIG. 5 illustrates an insulated probe of a liquid metal level measurement system according to one or more implementations of the present disclosure.

FIG. 6 is a process flow chart summarizing one implementation of a liquid metal level measurement system according to one or more implementations of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Reference will now be made in detail to the various implementations of the present disclosure, one or more examples of which are illustrated in the figures. Within the following description of the drawings, the same reference numbers refer to the same components. Generally, only the differences with respect to individual implementations are described. Each example is provided by way of explanation of the present disclosure and is not meant as a limitation of the present disclosure. Further, features illustrated or described as part of one implementation can be used on or in conjunction with other implementations to yield yet a further implementation. It is intended that the description includes such modifications and variations.

Many of the details, dimensions, angles and other features shown in the Figures are merely illustrative of particular implementations. Accordingly, other implementations can have other details, components, dimensions, angles and features without departing from the spirit or scope of the present disclosure. In addition, further implementations of the disclosure can be practiced without several of the details described below.

According to some implementations, systems and methods for the measurement of a liquid level in a crucible are provided. The phrases “liquid metal,” “liquid,” and “liquid alloy” are used interchangeably. The term refractory refers to a substance that is resistant to heat. The “level” of a liquid metal in a crucible refers to the distance of the top of the liquid metal from the interior bottom of the crucible.

Crucibles are used in a variety of industries for melting and transferring metals and other substances with high melting points. Proper control of the melting and transferring processes involves knowledge of the volume of metal contained in the crucible. Because the temperatures used to melt crucible contents are high, it is oftentimes difficult to observe or take measurements of the contents of a crucible. Thus, it would be advantageous to have methods and systems for the accurate measurement of a liquid level in a crucible.

Implementations of the present disclosure provide for a system and methods for the measurement of a liquid level in a crucible. The liquid can be a molten metal, a molten alloy, or other substance that melts at temperatures of greater than about 400° C. In some embodiments, a system for the measurement of a liquid level in a crucible includes a probe that is fixedly coupled to the crucible, and a processing system. In some implementations, the probe is an insulated probe and includes a probe body that is made of a refractory material. In some implementations, the probe body includes a refractory material on a probe body exterior. The probe can further include an electrode disposed at a lowermost probe position. The processing system is configured to receive a signal from the electrode to evaluate whether the electrode is in contact with the liquid within the crucible. The crucible can be made of an electrically-conductive material, such as stainless steel, and can be grounded.

The insulated probe can be provided within or can extend into the crucible volume. In some implementations, at least a portion of the insulated probe can reside within the crucible volume. In some implementations, the probe includes an electrically-conductive component, at least a portion of which is disposed within a probe interior, that electrically-couples the electrode to a processing system. The electrically-conductive component disposed within the probe interior can be made of the same material as the electrode, or from a different material.

In some implementations, the crucible, liquid metal, electrode, and electrically-conductive component are parts of a circuit comprised within the liquid metal measurement system. When the metal in the crucible is below the level of the electrode, i.e., not in contact with the electrode, the circuit is in an “open” or “complete” state. When the liquid metal in the crucible is at or above the level of the electrode, the metal is in contact with the electrode, and the circuit is in a “closed” state. The circuit can provide the processing system with the circuit status by sending an “open” or “closed” circuit status to the processing system. When the liquid within the crucible is not in contact with the electrode, the circuit is in an “open” state, and the processing system can determine that the liquid level within the crucible is below the level of the electrode. When the liquid within the crucible is in contact with the electrode, the circuit is in a “closed” or “complete” state, and the processing system can determine that the liquid level within the crucible is at or above the level of the electrode.

In some implementations, the probe is provided with an insulating material on a probe body exterior. The insulating material can be any refractory material that is capable of insulating the probe interior from high temperatures, e.g., temperatures of 400° C. and greater. In some embodiments, the insulating material is boron nitride. In some implementations, the probe includes an electrode at a lowermost probe position. In some embodiments, the probe further includes an insulating cap provided between a probe body and the electrode. The insulating cap is configured to to prevent high temperature crucible contents from entering the probe interior. In some embodiments, the electrode does not have an insulating material on the electrode exterior. The electrode can be made of stainless steel, or other electrically-conductive material known to those of skill in the art. In some aspects, the probe further includes a hollow interior. An electrically-conductive component can be provided within the probe interior. The electrically-conductive component is configured to electrically couple the electrode to the processing system.

In some implementations, a liquid metal level measurement system comprises a crucible, at least two insulated probes, and a processing system, where each of the at least two insulated probes includes an electrode at a respective lowermost probe position, and the at least two electrodes are provided at different heights within the crucible volume. The liquid metal level measurement system further includes a multi-loop circuit with each of the at least two electrodes forming part of a switch within each distinct circuit loop. The processing system can receive a signal from each of the at least two electrodes and evaluate whether each of the at least two electrodes is in contact with the liquid metal.

Implementations of the present disclosure further provide for a method for measuring a liquid metal level within a crucible. The method includes providing a liquid metal to a crucible, receiving a signal from each electrode with a processing system that is configured to evaluate whether each electrode is in contact with the liquid metal. The method further includes determining, with the processing system, the level of the liquid metal in the crucible relative to the heights or levels of the electrodes within the crucible.

Implementations of the present disclosure include one or more of the following advantages. The liquid metal level measurement systems can be adapted to crucibles that are sealed to isolate the crucible interior from the ambient environment. The liquid metal level measurement systems can therefore be used in systems where there is no direct line of sight to the crucible interior. The liquid metal level measurement systems can forgo the use of level-sensing thermocouples, which can receive aberrant temperature signals from the high crucible temperature environment. Additionally, the use of boron nitride insulating material and stainless steel electrodes allows the measurement systems disclosed herein to be used at temperatures of up to 1,400° C.

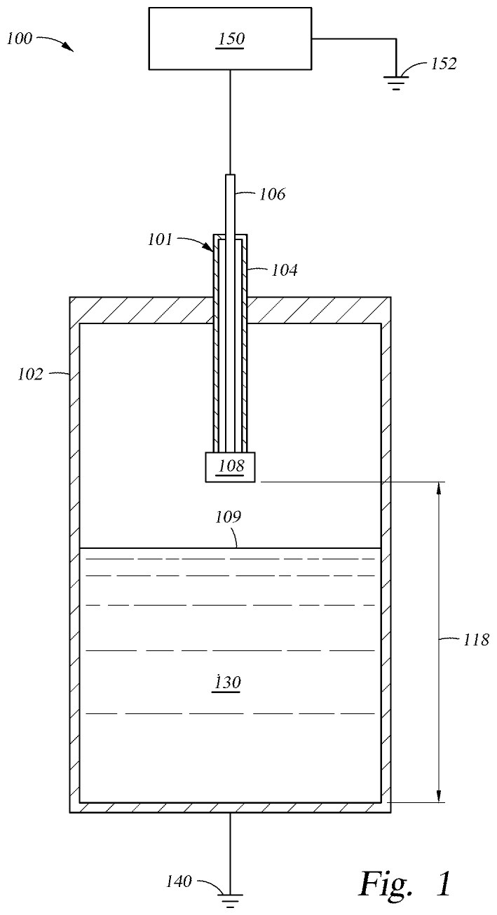

FIG. 1 illustrates a schematic side view of a liquid metal level measurement system 100 according to one or more implementations of the present disclosure. The liquid metal level measurement system 100 includes a crucible 102 that is made of an electrically-conductive material, e.g., stainless steel. The crucible 102 is grounded at a grounding location 140. The system comprises a probe 101 that includes a probe body 104. The probe body 104 can be made of an insulating material or can include an insulating material on a probe exterior. An electrode 108 is provided at a lowermost position of the probe 101. The electrode 108 is at a distance 118 above the crucible bottom. In some embodiments, the electrode 108 is made of an electrically-conductive material and is not provided with an insulating material on its exterior. The probe 101 further includes an electrically-conductive component 106 within a probe body interior that electrically couples the electrode 108 to a processing system 150. The electrically-conductive component 106 can be, for example, an electrically-conductive wire, an electrically-conductive rod, or a combination thereof. The processing system 150 is grounded at a grounding location 152 and includes an energy source. The processing system 150 is configured to receive a signal from the electrode 108, through the electrically-conductive component 106. An amplifier (not depicted) for amplifying a signal from the electrode 108 can be included upstream of the processing system 150, or can be incorporated within the processing system 150.

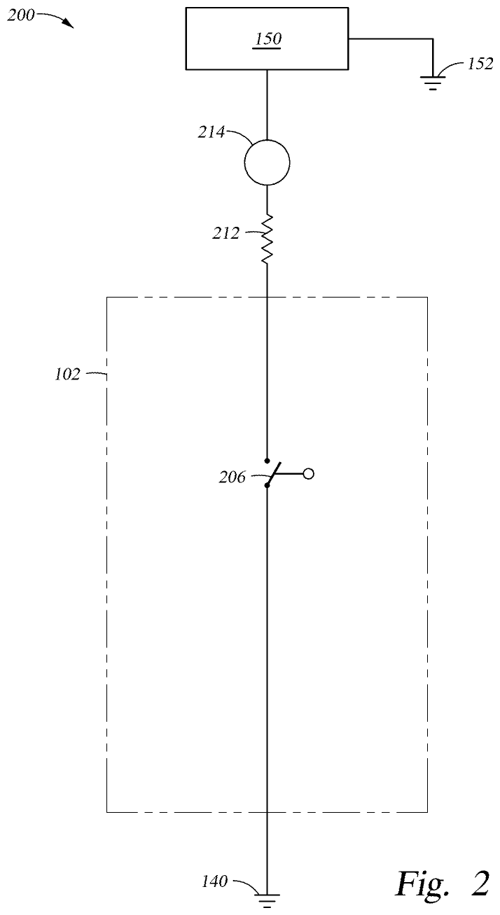

The crucible 102 is configured to contain a liquid metal 130. The top of the liquid metal in the crucible 102 is at the level 109. The electrode 108 is not in contact with the liquid metal 130, as the level 109 of the liquid metal 130 is below the position of the electrode 108 within the crucible 102. The grounded crucible 102, the liquid metal 130, the electrode 108, the electrically-conductive component 106, and the grounded processing system 150 together form a circuit 200 (FIG. 2). As depicted in the circuit schematic in FIG. 2, an amplifier 214 can optionally be included to amplify a signal provided through the circuit 200. The amplifier 214 can be positioned upstream of the processing system 150, or can be incorporated within the processing system 150. The processing system 150 is configured to receive a signal from the electrode 108, through the electrically-conductive component 106, to evaluate whether the electrode is in contact with the liquid metal 130.

The circuit 200 includes a switch 206 that can be in an “open” state or a “closed” state. The open and closed states of the switch 206 represent contact status between the liquid metal 130 and the electrode 108 in FIG. 1. When the level 109 of liquid metal 130 within the crucible 102 is below the position of the electrode 108 (as in the examples depicted in FIG. 1 and FIG. 2), the liquid metal 130 is not in contact with the electrode 108, and the switch 206 is regarded as being in an “open” state. When the level 109 of the liquid metal 130 within the crucible 102 is at or above the position of the electrode 108, the liquid metal 130 is in contact with the electrode 108, and the switch 206 is regarded as being in a “closed” state. When the switch 206 is in a closed state, the grounded crucible 102, the liquid metal 130, the electrode 108, the electrically-conductive component 106, and the grounded processing system 150 are in electrical communication and the circuit 200 is complete. The processing system 150 can then provide a system operator with information on the level of the liquid metal 130 within the crucible 102. In the embodiment depicted in FIG. 1, the processing system 150 can inform a system operator if the level 109 of the liquid metal 130 within the crucible 102 is below the position of the electrode 108, or if the level 109 of the liquid metal 130 is at or above the position of the electrode 108. The “position of the electrode 108” refers to the vertical position of the electrode 108 within the crucible 102.

As further depicted in the circuit schematic in FIG. 2, a resistor 212 can optionally be included. The resistor 212 can be positioned upstream of the amplifier 214, if present, and the processing system 150, or can be incorporated within the processing system 150, and downstream of the switch 206.

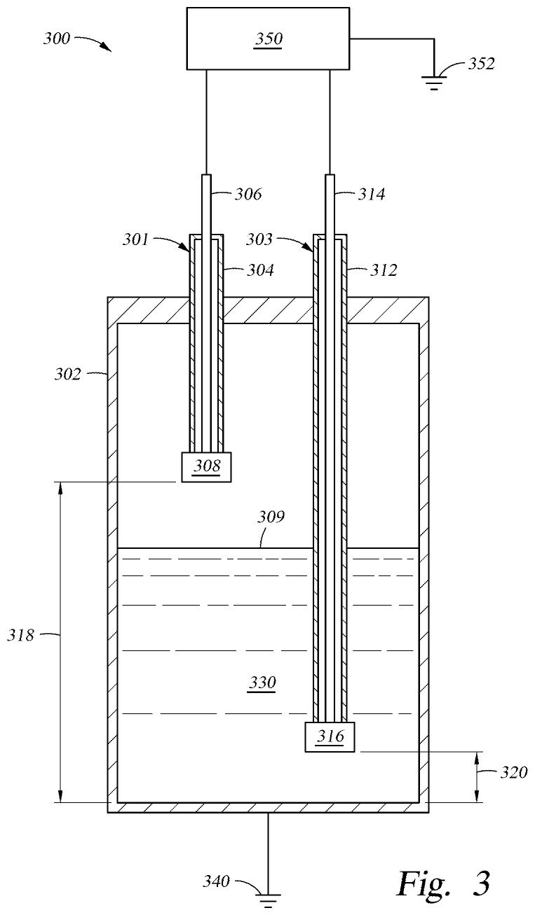

FIG. 3 illustrates a schematic side view of a dual-probe liquid metal level measurement system 300 according to one or more implementations of the present disclosure. The dual-probe liquid metal level measurement system 300 includes a crucible 302 that is made of an electrically-conductive material and is grounded at a grounding location 340. The dual-probe liquid metal level measurement system 300 further includes a first probe 301 and a second probe 303. The first probe 301 includes a first probe body 304 that can be made of an insulating material. In some embodiments, the first probe body 304 is provided with a layer of insulating material on a probe body exterior. The first probe 301 further includes a first electrode 308, and a first electrically-conductive component 306 located within the probe body 304. The first electrically-conductive component 306 serves to electrically couple the first electrode 308 to a processing system 350. The processing system 350 is grounded at a grounding location 352 and includes an energy source. The first electrode 308 is positioned at a first distance 318 from the bottom of the interior of the crucible 302. The second probe 303 includes a second probe body 312 that can be made of an insulating material. In some embodiments, the second probe body 312 is provided with a layer of insulating material on a probe body exterior. The second probe 303 further includes a second electrode 316, and a second electrically-conductive component 314 located within the second probe body 312. The second electrically-conductive component 314 serves to electrically couple the second electrode 316 to the processing system 350. The second electrode 316 is positioned at a second distance 320 from the bottom of the interior of the crucible 302.

In some embodiments, the first electrically-conductive component 306 and the second electrically-conductive component 314 are made of the same material. In some embodiments, the first electrically-conductive component 306 and the second electrically-conductive component 314 are made of different materials. In some embodiments, the insulating material used to make the first probe body 304 is the same as the insulating material used to make the second probe body 312. In some embodiments, the insulating material used to make the first probe body 304 is different from the insulating material used to make the second probe body 312. In some embodiments, the insulating material that is provided on an outer surface of the first probe body 304 is the same as the insulating material that is provided on an outer surface of the second probe body 312. In some embodiments, the insulating material that is provided on an outer surface of the first probe body 304 is different from the insulating material that is provided on an outer surface of the second probe body 312.

The crucible 302 is configured to contain a liquid metal 330. The top of the liquid metal in the crucible 302 is at the liquid metal level 309. The first electrode 308 is at the first distance 318 from the bottom of the crucible 302, which is greater than the liquid metal level 309 of the liquid metal 330 in the crucible 302. The first electrode 308 is above the liquid metal level 309 and therefore not in contact with the liquid metal 330. The second electrode 316 is at a second distance 320 from the bottom of the crucible 302. The second distance 320 is less than the liquid metal level 309 of liquid metal 330 in the crucible 302. The second electrode 316 is below the liquid metal level 309 and is therefore in contact with the liquid metal 330.

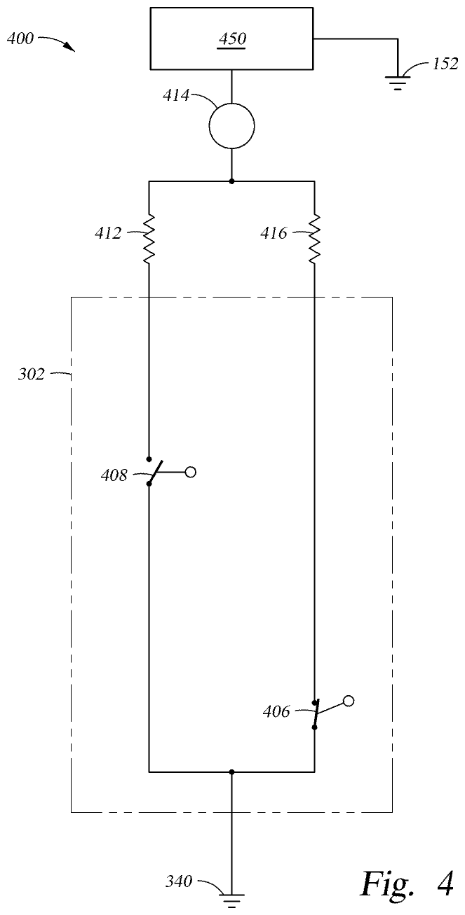

The circuit schematic depicted in FIG. 4 represents the operational components of FIG. 3. The grounded crucible 302, the liquid metal 330, the first electrode 308, the first electrically-conductive component 306, the second electrode 316, the second electrically-conductive component 314, and the grounded processing system 350 together form a circuit 400 (FIG. 4). As depicted in the circuit schematic in FIG. 4, an amplifier 414 can optionally be included to amplify a signal provided through the circuit 400. The amplifier 414 can be positioned upstream of the processing system 450, or can be incorporated within the processing system 450. The processing system 450 is configured to receive a signal from the first electrode 308, through the first electrically-conductive component 306, to evaluate whether the first electrode 308 is in contact with the liquid metal 330. The processing system 450 is further configured to receive a signal from the second electrode 316, through the second electrically-conductive component 314, to evaluate whether the second electrode 316 is in contact with the liquid metal 330.

The circuit 400 further includes a first switch 408 and a second switch 406. As depicted in the circuit schematic in FIG. 4, an amplifier 414 can optionally be included to amplify a signal provided through the circuit 400. The amplifier 414 can be positioned upstream of the processing system 450, or can be incorporated within the processing system 450. As further depicted in the circuit schematic in FIG. 4, the circuit can further includes a first resistor 412 a second resistor 416. The first resistor 412 can be positioned upstream of the amplifier 414, if present, and the processing system 450, or can be incorporated within the processing system 450, and downstream of the first switch 408. The second resistor 416 can be positioned upstream of the amplifier 414, if present, and the processing system 450, or can be incorporated within the processing system 450, and downstream of the second switch 406.

The crucible 302 is grounded at a grounding location 340. Within the crucible 302 are the first switch 408 and the second switch 406. The first switch 408 is in an open state, and the open state represents “no contact” between the liquid metal 330 and the first electrode 308 of FIG. 3. The second switch 406 is in a closed state, and the closed state represents “contact” between the liquid metal 330 and the second electrode 316 of FIG. 3. The first switch 408 and the second switch 406 statuses are received and amplified by the amplifier 414 and sent to a processing system 450. The processing system 450 can then provide a system operator with information on the level of liquid metal within the crucible 302. In the example depicted in FIG. 3 and the corresponding circuit 400 depicted in FIG. 4, the processing system 450 receives information indicating that the liquid metal 330 in the crucible 302 is in contact with the second electrode 316, and is not in contact with the first electrode 308. Using this information, the processing system 150 can inform a system operator that the level of the liquid metal 330 in the crucible 302 is at or above the vertical position of second electrode 316, and below the vertical position of first electrode 308.

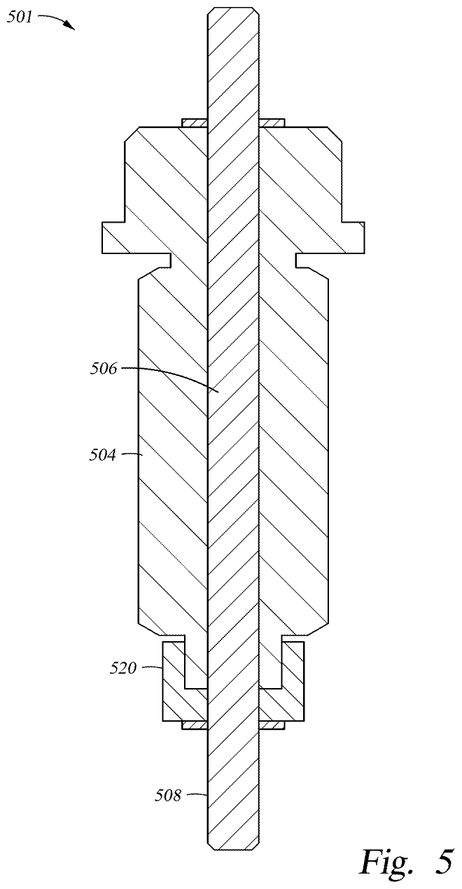

FIG. 5 depicts a probe 501, according to one or more implementations of the present disclosure. The probe 501 includes a probe body 504. The probe body 504 can be made of an insulating material. In some embodiments, the probe body 504 is provided with a layer of insulating material on a probe body exterior. The probe 501 further includes an electrode 508 provided at a lowermost position of the probe 501. A cap 520 is configured to seal a probe interior from liquid metal in the crucible. Within the probe interior is an electrically-conductive component 506. The electrically-conductive component 506 is configured to electrically couple the electrode 508 to an amplifier and/or a processing system. In the embodiment depicted in FIG. 5, the electrode 508 and the electrically-conductive component 506 comprise a unitary construction, however, in some embodiments, the electrode 508 and the electrically-conductive component 506 are provided as distinct components.

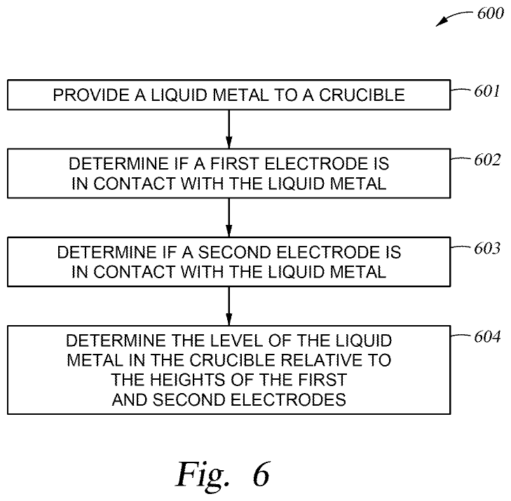

FIG. 6 illustrates a process flow chart 600 summarizing one implementation of a method for measuring a liquid metal or alloy within a crucible, according to one or more implementations of the present disclosure. In one implementation, which may be combined with other implementations described herein, the method is stored on a computer readable medium. In one implementation, which may be combined with other implementations described herein, the method is performed using a processing system. The method is described with reference to FIG. 3 and FIG. 4.

At operation 601, a liquid metal is provided to a crucible comprising first and second probes fixedly coupled to a crucible interior. Each of the first and second probes includes an electrode at a lowermost position of the respective probe. The first and second probes are of different lengths such that the first and second electrodes are provided at different heights within the crucible volume. At operation 602, the processing system determines if the first electrode, provided at a first height within the crucible volume, is in contact with the liquid metal. At operation 603, the processing system determines if the second electrode, provided at a second height within the crucible volume, is in contact with the liquid metal. At operation 604, the processing system uses the information gathered at operations 602 and 603 to determine the level of the liquid metal within the crucible relative to the heights of the first and second electrodes.

A liquid metal level measurement system as disclosed herein can include any number of probes within the crucible volume. For example, a liquid metal level measurement system as disclosed herein can include 1, 2, 3, 4, 5, 6, 7, 8, 9, 10, or more probes within a crucible volume. Each probe includes an electrode at a lowermost probe position. The probes and respective electrodes are configured such that each electrode is provided at a different height within the crucible volume. A liquid metal level measurement system that includes an integer number of probes “n” can provide information to a system user on metal levels at “n+1” number of sectors within the crucible. For example, a liquid metal level measurement system that includes a single probe and a single corresponding electrode (n=1) can determine if the liquid level is in one of two sectors (n+1=2). The single probe liquid metal level measurement system can determine if the liquid level is below the single electrode (i.e., a first sector), or if the liquid level is at or above the single electrode (i.e., a second sector).

Similarly, a liquid metal level measurement system that includes two probes (n=2) and two corresponding electrodes (a lower electrode and an upper electrode) can determine if the liquid level is in one of three (n+1=3) sectors. The dual-probe liquid metal level measurement system can determine if the liquid level is below the lower electrode (i.e., a first sector). The dual-probe liquid metal level measurement system can determine if the liquid level is below the upper electrode and at or above the lower electrode (i.e., a second sector). Finally, the dual-probe liquid metal level measurement system can determine if the liquid level is at or above the third electrode (i.e., a third sector).

A liquid metal level measurement system that includes three probes (n=3) and three corresponding electrodes (a lower electrode, a central electrode, and an upper electrode) can determine if the liquid level is in one of four (n+1=4) sectors. The three-probe liquid metal level measurement system can determine if the liquid level is below the lower electrode (i.e., a first sector). The three-probe liquid metal level measurement system can determine if the liquid level is below the central electrode and at or above the lower electrode (i.e., a second sector). The three-probe liquid metal level measurement system can determine if the liquid level is below the upper electrode and at or above the central electrode (i.e., a third sector). Finally, the three-probe liquid metal level measurement system can determine if the liquid level is at or above the upper electrode (i.e., a fourth sector). By using n number of electrodes, a liquid metal level measurement system can determine if a liquid level is at one of n+1 number of sectors within a crucible.

A liquid metal level measurement system as disclosed herein can include a controller operable to control various aspects of the liquid metal level measurement system. The controller can facilitate the control and automation of the level measurement system and can include a central processing unit (CPU), memory, and support circuits (or I/O). Software instructions and data can be coded and stored within the memory for instructing the CPU. The controller can communicate with one or more of the components of the level measurement system via, for example, a system bus. A program (or computer instructions) readable by the controller determines which measurements are to be taken. In some aspects, the program is software readable by the controller, which can include code for monitoring crucible conditions and detecting electrode statuses. It should be appreciated that multiple system controllers can be used with the aspects described herein. The controller can be one of any form of general-purpose computer processor that can be used in an industrial setting for controlling various crucibles and sub-processors.

The controller can be provided and coupled to various components of the processing system to control the operation thereof. The methods as described herein may be stored in a memory of the controller as software routine that may be executed or invoked to control the operation of the level measurement system in the manner described herein.

Implementations and all of the functional operations described in this specification can be implemented in digital electronic circuitry, or in computer software, firmware, or hardware, including the structural means disclosed in this specification and structural equivalents thereof, or in combinations of them. Implementations described herein can be implemented as one or more non-transitory computer program products, i.e., one or more computer programs tangibly embodied in a machine readable storage device, for execution by, or to control the operation of, data processing apparatus, e.g., a programmable processor, a computer, or multiple processors or computers.

The method described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

In summary, some of the benefits of the present disclosure include the ability to remotely detect the level of a liquid metal within a crucible. The crucible can be a sealed crucible with no direct line of sight to the crucible interior. The liquid metal level measurement systems can be used to detect the level of liquid metal in a sealed crucible with no direct line of sight. The liquid metal level measurement systems can be provided with multiple probes to determine if liquid levels in the crucible are within multiple height sectors within the crucible. The liquid metal level measurement systems do not rely on the use of thermocouples, which can receive aberrant temperature signals from the high crucible temperature environment. Additionally, the use of boron nitride insulating material and stainless steel electrodes allows the measurement systems disclosed herein to be used at temperatures of up to 1,400° C. The liquid metal level measurement systems can be used to prevent underfilling and overfilling of a crucible.

When introducing elements of the present disclosure or exemplary aspects or implementation(s) thereof, the articles “a,” “an,” “the” and “said” are intended to mean that there are one or more of the elements.

The terms “comprising,” “including” and “having” are intended to be inclusive and mean that there may be additional elements other than the listed elements.

While the foregoing is directed to implementations of the present disclosure, other and further implementations of the disclosure may be devised without departing from the basic scope thereof, and the scope thereof is determined by the claims that follow.

What is claimed is:

1. A liquid metal level measurement system, comprising:
a crucible operable to contain a liquid metal;
a probe fixedly coupled to the crucible, comprising:
an electrode disposed at a lowermost probe position; and
a processing system configured to receive a signal from the electrode to evaluate whether the electrode is in contact with the liquid metal.

2. The liquid metal level measurement system of claim 1, wherein the probe further comprises an electrically-conductive component disposed within a probe interior and electrically-coupled to the electrode and the processing system.

3. The liquid metal level measurement system of claim 1, wherein the crucible comprises an electrically-conductive material.

4. The liquid metal level measurement system of claim 1, wherein the crucible is grounded.

5. The liquid metal level measurement system of claim 1, further comprising a circuit configured to provide an open/closed signal to the processing system.

6. The liquid metal level measurement system of claim 5, wherein the circuit is configured to send an open circuit status signal to the processing system when the electrode is not in contact with liquid metal.

7. The liquid metal level measurement system of claim 5, wherein the circuit is configured to send a closed circuit status signal to the processing system when the electrode is in contact with liquid metal.

8. The liquid metal level measurement system of claim 1, wherein the probe is made of an insulating material.

9. The liquid metal level measurement system of claim 1, wherein the probe comprises an insulating material on a probe exterior.

10. The liquid metal level measurement system of claim 1, wherein the electrode comprises stainless steel.

11. A liquid metal level measurement system, comprising:
a crucible comprising an electrically-conductive material and operable to contain a liquid metal;
at least two probes fixedly coupled to the crucible, wherein each of the at least two probes comprises an electrode at a respective lowermost probe position and disposed within a crucible volume; wherein the at least two electrodes are electrically-coupled to a multi-loop circuit; and
a processing system configured to receive a signal from each of the at least two electrodes to evaluate whether each of the at least two electrodes is in contact with the liquid metal.

12. The liquid metal level measurement system of claim 11, wherein each of the at least two electrodes is provided at a different height within the crucible volume.

13. The liquid metal level measurement system of claim 11, wherein the crucible is grounded.

14. The liquid metal level measurement system of claim 11, wherein each of the at least two probes further comprises an electrically-conductive component disposed within a probe interior and electrically-coupled to a respective electrode and the processing system.

15. The liquid metal level measurement system of claim 11, wherein the multi-loop circuit is configured to provide an open/closed circuit loop signal for each circuit loop to the processing system.

16. The liquid metal level measurement system of claim 15, wherein each of the at least two electrodes is configured to function as a switch for a distinct circuit loop.

17. The liquid metal level measurement system of claim 16, wherein a circuit loop is configured to send a closed circuit loop state signal to the processing system when a corresponding electrode is in contact with liquid metal.

18. The liquid metal level measurement system of claim 16, wherein a circuit loop is configured to send an open circuit loop state signal to the processing system when a corresponding electrode is not in contact with liquid metal.

19. A method of measuring a liquid metal level within a crucible, comprising:
providing a liquid metal to a crucible, wherein the crucible comprises:
at least one insulated probe fixedly coupled to the crucible, wherein each of the at least one probe comprises an electrode disposed at a lowermost probe position and within a crucible volume;
receiving a signal from each of the at least one electrode with a processing system that is configured to evaluate whether each of the at least one electrodes is in contact with the liquid metal;
determining, with the processing system, a liquid metal level relative to a height of each of the at least one electrode within the crucible.

20. The method of claim 19, further comprising at least two electrodes, wherein each of the at least two electrodes is provided at a different height within the crucible.
